(19) United States
(12) Patent Application Publication
(10) Pub. No.: US 2024/0396766 A1
(43) Pub. Date: Nov. 28, 2024

(54) IMPROVED PILOT ASSISTED RADIO PROPAGATION CHANNEL ESTIMATION BASED ON MACHINE LEARNING

(71) Applicant: Telefonaktiebolaget LM Ericsson (publ), Stockholm (SE)

(72) Inventors: Jaeseong Jeong, Solna (SE); Zhao Wang, Täby (SE); Heunchul Lee, Täby (SE)

(21) Appl. No.: 18/691,698

(22) PCT Filed: Jan. 18, 2022
(86) PCT No.: PCT/EP2022/051010

§ 371 Date: Mar. 13, 2024

(30) Foreign Application Priority Data
Sep. 14, 2021 (WO) PCT/EP2021/075202

(51) Int. Cl. H04L 25/02; H04L 27/26

(52) U.S. Cl. CPC H04L 25/0254; H04L 27/26532

(57) ABSTRACT

A method for estimation of a radio propagation channel realization, performed in a wireless communication system comprising one or more access points and one or more wireless devices, the method comprising obtaining a generative adversarial network (GAN) structure comprising a generative part and a discriminative part; configuring the GAN structure as a conditioned GAN structure, where the generative part is arranged to be conditioned by pilot symbol data comprising radio propagation channel data obtained from pilot symbol transmissions over the radio propagation channel; training the GAN structure by conditioning the generative part on the pilot symbol data and feeding a corresponding output to the discriminative part together with reference channel realization data corresponding to the pilot symbol data; extracting a channel estimator from the GAN structure and estimating a radio propagation channel realization by feeding pilot symbol data to the channel estimator.

### TECHNICAL FIELD

The present disclosure relates to techniques for performing radio propagation channel estimation in a wireless communication system. The techniques are based on machine learning, and in particular machine learning techniques based on generative adversarial networks (GAN).

### BACKGROUND

Multi-carrier transmission, such as orthogonal frequency division multiplexing (OFDM) is a key enabler in modern cellular access networks, such as the fifth generation (5G) and sixth generation (6G) wireless access networks defined by the third generation partnership program (3GPP).

Most wireless access networks rely to a considerable extent on knowledge of the characteristics of the radio propagation channel between transmitter and receiver, which is achieved by means of various radio propagation channel estimation techniques. Having knowledge of the current radio channel propagation realization enables more spectrally efficient communication, such as techniques based on adaptive coding and modulation, and also multi-antenna communications such as beam-forming techniques and multi-input multiple-output (MIMO) data transmission.

The radio propagation channel is commonly estimated based on the transmission of pilot symbols, which comprise some a-priori known structure and often also a-priori known data symbols. For instance, some 3GPP standards define reference signals such as sounding reference signal (SRS) and demodulation reference signal (DMRS) which are used to gain knowledge about the radio propagation channel between transmitter and receiver. SRS and DMRS transmission are discussed in more detail in 3GPP TS 38.211 v16.6.0. Other pilot symbol transmission schemes are also known.

The pilot symbols are transmitted at specific communication resources, i.e., at specific frequency sub-bands and during pre-determined time slots. Consequently, the radio propagation channel characteristics such as gain, and phase-shift, are relatively well known for these specific frequencies and time slots. Since the radio propagation channel is not directly measured in-between the pilot symbol frequencies and/or in-between the pilot symbol transmission time slots, some parts of the radio channel are more uncertain in terms of radio channel characteristics than others. To gain knowledge of what the radio propagation channel looks like in-between the pilot symbol communication resources, least-squares (LS) based interpolation techniques can be applied. An alternative to the LS-based interpolation methods is proposed by Soltani, Mehran, et al. in “Deep learning-based channel estimation.” IEEE Communications Letters 23.4 (2019): 652-655. This technique is based on maximum likelihood (ML) image super resolution techniques.

Radio transmission, e.g., multiple-input multiple-output (MIMO) transmission on a downlink from a radio base station or access point to a wireless device in a wireless access network, may be adapted using the estimated radio propagation channel characteristics. Such adaptation can be based on channel information obtained from pilot symbols, e.g., SRS in 5G NR, received at the transmitter side, which is often possible due to channel reciprocity, i.e., since the radio propagation channels for transmission and reception are often similar, at least in time division duplex (TDD) systems. However, there is an inevitable delay between reception of pilot symbols and radio signal transmission in TDD systems, known as channel ageing, which often hampers system performance. This is especially true in dynamic systems where the radio propagation channel between the transceivers is time varying. Thus, despite the advancements made to-date, there is a need for further improvements in channel estimation for wireless communication systems.

### SUMMARY

It is an object of the present disclosure to provide methods, wireless devices, and network nodes which resolve or at least alleviate some or all of the above-mentioned issues.

This object is at least in part obtained by a method for estimation of a current radio propagation channel realization and/or prediction of a future radio propagation channel realization, performed in a wireless communication system comprising one or more access points and one or more wireless devices. The method comprises obtaining a generative adversarial network (GAN) structure, wherein the GAN structure comprises a generative part and a discriminative part and configuring the GAN structure as a conditioned GAN structure, where the generative part is arranged to be conditioned by pilot symbol data comprising radio propagation channel data obtained from pilot symbol transmissions over the radio propagation channel. The method also comprises training the GAN structure by conditioning the generative part on the pilot symbol data and feeding a corresponding output from the generative part to the discriminative part together with reference channel realization data corresponding to the pilot symbol data, and extracting a channel estimator from the GAN structure, the channel estimator being the generative part of the GAN structure, and also estimating a radio propagation channel realization by feeding pilot symbol data to the channel estimator.

This way a channel estimator is obtained which is able to estimate the radio propagation channel in-between the communication resources (time and/or frequency resources) occupied by pilot symbols more accurately, and potentially also the radio propagation channel realizations at the pilot symbol communication resources. Depending on how the GAN structure is trained, the channel estimator can also be customized in an advantageous manner to estimate radio propagation channels more accurately in specific environments. The wireless communication system is preferably an orthogonal frequency division multiplexed (OFDM) based system, where the pilot symbol transmissions comprise transmission of sounding reference signal (SRS) and demodulation reference signal (DMRS) resource elements (RE). However, the methods are not limited to these types of systems. Rather, the techniques disclosed herein are generally applicable in many types of wireless communication systems.

The channel estimators discussed herein can be trained by conditioning the generative part of the GAN structure on the pilot symbol data and feeding a corresponding output from the generative part to the discriminative part together with reference channel realization data concurrent with the pilot symbol data and extracting a channel estimator for estimating a current channel realization from the GAN structure. The channel estimators in the present disclosure can also be trained by conditioning the generative part of the GAN structure on the pilot symbol data and feeding a corresponding output from the generative part to the discriminative part together with reference channel realization data contiguous in time to the pilot symbol data and extracting a channel predictor for estimating a future channel realization from the GAN structure. Here, “contiguous in time” means preceding or following in time, i.e., that the reference channel realization data is adapted to enable prediction of a future channel realization which may be adjacent to the reference channel realization data in time or more time distant compared to the reference channel realization data.

The methods disclosed herein may be performed with advantage in part or entirely in one of the access points, in one of the wireless devices, and/or in a remote server. The method may also be performed jointly in more than one device, such as in two or more access points, or in collaboration between an access points and the wireless device.

According to aspects, the training is performed until a termination criterion associated with a capability of the generative part to generate an output classified as a true channel realization by the discriminative part. This is a robust termination criterion which has been found to work well in many different types of radio channel propagation environments. Termination criteria will be discussed in detail below.

According to aspects, the method also comprises performing an offline training procedure comprising generating the pilot symbol data and the reference channel realization data by computer simulation of a radio propagation channel model. This means that the amount of training data is, essentially, unlimited, since the channel model can be used to generate more data as needed. The radio propagation channel model may comprise any of a 3GPP tapped delay line (TDL) model, a 3GPP clustered delay line (CDL) model, and a 3GPP spatial channel model (SCM) model.

According to aspects, the method also comprises performing an additional online training procedure involving pilot symbol transmissions over a radio propagation channel between an access point and a wireless device in the wireless communication system. The additional online training provides a level of customization to the current radio channel environment. This means that a more accurate channel estimate can be obtained. The offline training procedure can also be used as initialization for an online training procedure, thereby reducing the convergence time of the online training, which is an advantage. The additional online training procedure may comprise, e.g., a transfer learning method and/or a meta learning method.

The method may furthermore comprise performing an online training procedure comprising extracting the pilot symbol data and the reference channel realization data from an ongoing communication in the wireless communication system. This is a particularly efficient way to train the GAN structure in terms of overhead signalling since there is a limited need for transmission of pilot symbols. The training is instead at least partly based on information-bearing symbols, i.e., data symbols transmitted as part of the data transfer between wireless device and access point. The ongoing communication in the wireless communication system may, for instance, comprise a transmission of pilot-weaved frames comprising only known information symbols, as will be discussed in more detail below. The ongoing communication in the wireless communication system may also comprise a transmission of pilot-weaved frames comprising predetermined (standard-compliant) pilot symbol patterns and pseudo-pilot symbols.

Further advantages may be obtained by extracting one or more (standard-compliant) pilot symbol patterns from the received pilot-weaved frames. The pilot symbol patterns may correspond to pilot symbol which can be encountered. Thus, the training can be done in parallel for two or more different pilot symbol patterns.

According to aspects, the method comprises comprising training the GAN structure using a respective cross entropy loss function for each of the generative part and the discriminative part. Cross entropy functions have been shown to work well in training GAN structures in previous applications and have shown good results also for these GAN structures. Alternatively, or in combination, the method also comprises training the GAN structure using a loss function comprising an adversarial loss and a Euclidean distance between the output from the generative part and the corresponding reference channel realization data

The method optionally comprises training the GAN structure at an access point of the wireless communication system based on communication over an uplink (UL) from a first wireless device to the access point and transmitting the channel estimator to the first wireless device upon the generative part of the GAN structure reaching a predetermined convergence criterion. Thus, a significant part of the processing can be performed at an access point which normally has more extensive power and processing resources compared to the wireless device. The discriminative part can also be downloaded to the first wireless device. This way the discriminative part can be used in a fault detection structure at the wireless device. The method may then also comprise triggering a fault condition in case the discriminative part indicates that an estimated channel realization is not a true channel realization. The methods may further comprise triggering generation of an alarm message to an operations and maintenance node in the wireless communication system in case the discriminative part indicates that an estimated channel realization is not a true channel realization.

According to aspects, the method further comprises transmitting a channel estimator trained at a first access point to the wireless device in response to the wireless device performing a handover procedure for service by the first access point. This means that the channel estimator used by the wireless device is updated with a new estimator potentially more tailored to the new cell, i.e., more accurate. The peculiarities of radio propagation specific to a given cell can then be reflected by the estimator, which is an advantage. The methods optionally also comprise transmitting a GAN channel estimator trained based on communication in a geographical area to the wireless device in response to the wireless device entering the geographical area. Again, this allows for customization of the channel estimator, resulting in increased channel estimation performance. In a similar manner, the methods may also comprise transmitting a channel estimator to the wireless device, where the channel estimator has been trained based on communication involving a specific type of wireless device, where the wireless device is associated with the specific type of wireless device. Again, this is likely to result in an improved performance of the channel estimator since it can now be tailored to the specific properties of the wireless device.

According to some aspects, particularly when the channel estimator is used for channel prediction, a time delay between the reference channel realization data and the pilot symbol data is configured to correspond to a delay between reception of pilot symbol data and a radio transmission. This mitigates channel ageing effects, which is an advantage.

According to other aspects, the method comprises training the GAN structure for a plurality of different time delays between the pilot symbol data and the reference channel realization data. This allows a transceiver to select a suitable GAN structure in dependence of, e.g., a frame structure of the communication system in which it is currently being used.

The method optionally also comprises training the GAN structure to estimate and/or predict a radio propagation channel realization as a channel response comprising complex elements in a MIMO channel matrix, and/or vectors spanning a MIMO channel matrix eigen-vector space and/or a MIMO channel precoding matrix index.

The above-mentioned advantages are also obtained by network nodes, wireless devices, and wireless communication systems described in detail below.

### BRIEF DESCRIPTION OF THE DRAWINGS

The present disclosure will now be described in more detail with reference to the appended drawings, where:

FIG. 1 shows aspects of an example communication system;

FIG. 2 shows an OFDM frame structure comprising reference symbols;

FIGS. 3-4 illustrate radio propagation channel realizations in temporal and frequency domain;

FIG. 5 conceptually illustrates channel estimation in an OFDM-based system;

FIG. 6 shows a GAN-based channel estimator;

FIG. 7 is a flow chart illustrating methods;

FIGS. 8A-D are signaling diagrams illustrating examples of the herein disclosed techniques;

FIG. 9 schematically illustrates transmission of a GAN-based trained channel estimator;

FIG. 10 schematically illustrates processing circuitry;

FIG. 11 shows a computer program product;

FIG. 12 conceptually illustrates channel estimation in an OFDM-based system;

FIGS. 13A-B illustrate example OFDM frame structures;

FIG. 14 illustrate example OFDM pilot symbol patterns;

FIG. 15 illustrates pilot symbol transmission used for channel prediction;

FIG. 16 illustrates estimation of concurrent and contiguous channel realizations;

FIG. 17 conceptually shows a GAN-based channel predictor structure;

FIG. 18 schematically shows a system for OFDM-based communication;

FIG. 19 is a signaling diagram illustrating examples of the herein disclosed techniques;

FIG. 20 schematically illustrates a processing architecture; and

FIG. 21 shows three example approaches (a-c) to GAN-based channel prediction.

### DETAILED DESCRIPTION

Aspects of the present disclosure will now be described more fully hereinafter with reference to the accompanying drawings. The different devices, systems, computer programs and methods disclosed herein can, however, be realized in many different forms and should not be construed as being limited to the aspects set forth herein. Like numbers in the drawings refer to like elements throughout.

The terminology used herein is for describing aspects of the disclosure only and is not intended to limit the invention. As used herein, the singular forms “a”, “an” and “the” are intended to include the plural forms as well, unless the context clearly indicates otherwise.

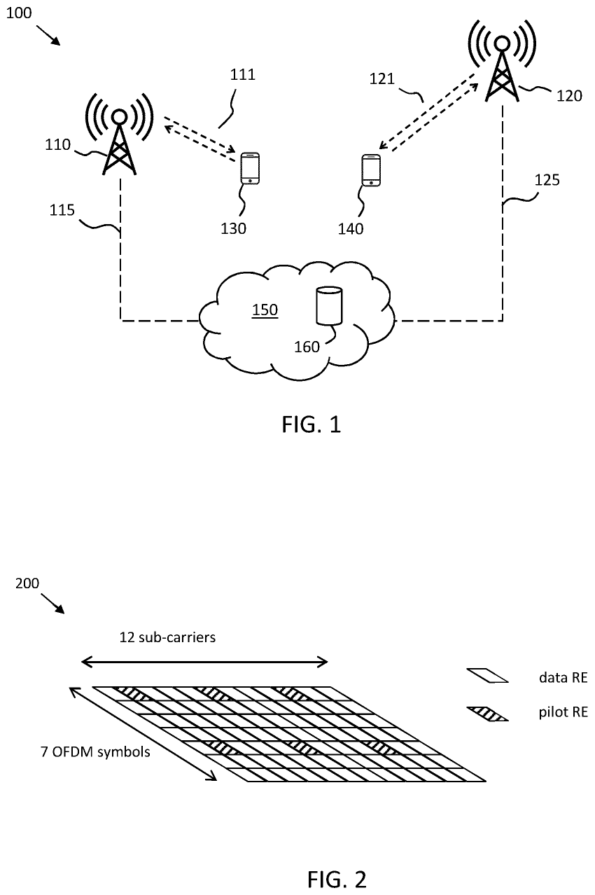

FIG. 1 illustrates an example wireless communication system 100, where access points 110, 120 provide wireless network access to wireless devices 130, 140, also known as user equipment (UE), over a coverage area. An access point in a fourth generation (4G) third generation partnership program (3GPP) network is normally referred to as an evolved node B (eNodeB), while an access point in a fifth generation (5G) 3GPP network is referred to as a next generation node B (gNodeB). The access points 110, 120 are connected 115, 125 to some type of core network 150, such as an evolved packet core network (EPC). The EPC is an example of a network which may comprise wired communication links, such as optical links. An access point may be associated with one or more transmission points (TRP) in a known manner. One or more remote servers 160 may be comprised in the core network. These remote servers may be used to store data and/or to perform various data processing operations.

The wireless access network 100 supports at least one radio access technology (RAT) for communicating 111, 121 with wireless devices 140, 150. It is appreciated that the present disclosure is not limited to any particular type of wireless access network type or standard, nor any particular RAT. The techniques disclosed herein are, however, particularly suitable for use with 3GPP defined wireless access networks, and in particular those based on orthogonal frequency division multiplexing (OFDM).

An important part of most modern wireless communication networks, and especially advanced multi-antenna OFDM-based communication systems such as 5G and 6G, is the continuous characterization of the radio propagation channel between transmitter and receiver. Knowledge of the current channel realization is necessary for features such as adaptive coding and modulation and multiple-input multiple-output (MIMO) operation to be effective. The continuous or periodic inference of the current channel realization is commonly known as channel estimation. Channel estimation is often based on the transmission of known information symbols over the radio propagation channel, which information symbols are known as pilot symbols or reference symbols. The continuous or periodic inference of future channel realizations which have not yet occurred is a form of channel estimation commonly known as channel prediction. Channel prediction is often based on received pilot symbols and on an assumption of channel reciprocity. Channel reciprocity refers to a common trait of many bi-directional radio propagation channels 111, 121 wherein radio propagation in one direction is similar to radio propagation in the other direction. This means that, e.g., a channel realization estimated based on pilot symbol transmission on uplink to an access point 110, 120 can be used also for transmission on the downlink from the access point 110, 120.

In a multi-carrier frame-based system, a group of resource elements (REs) may form a physical resource block (PRB) which is the basic resource allocation unit in many OFDM-based access networks. Data symbols are transmitted over data REs and the channels of pilot REs are probed via pilot symbols and used for channel estimation over the data REs. In order to recover the data symbols at the receiver side, the channels of data REs are estimated based on the received pilot symbols. In case of a block fading channel, the channel estimation is straightforward since all the data and pilot symbols will experience the same channel conditions in a frame. However, in more realistic scenarios such as during frequency selective fading, the channel estimation for the data REs becomes non-trivial.

FIG. 2 shows an example pilot symbol distribution 200 over a block of REs. There are six pilot REs distributed over a resource block comprised of 12 subcarriers and 7 OFDM symbols. Given the channel data obtained from observation of the pilot symbols, it is desired to estimate the channel properties at the data REs in-between the pilot REs. It may also be desired to predict radio propagation channel realizations forward in time, sometimes referred to as channel prediction.

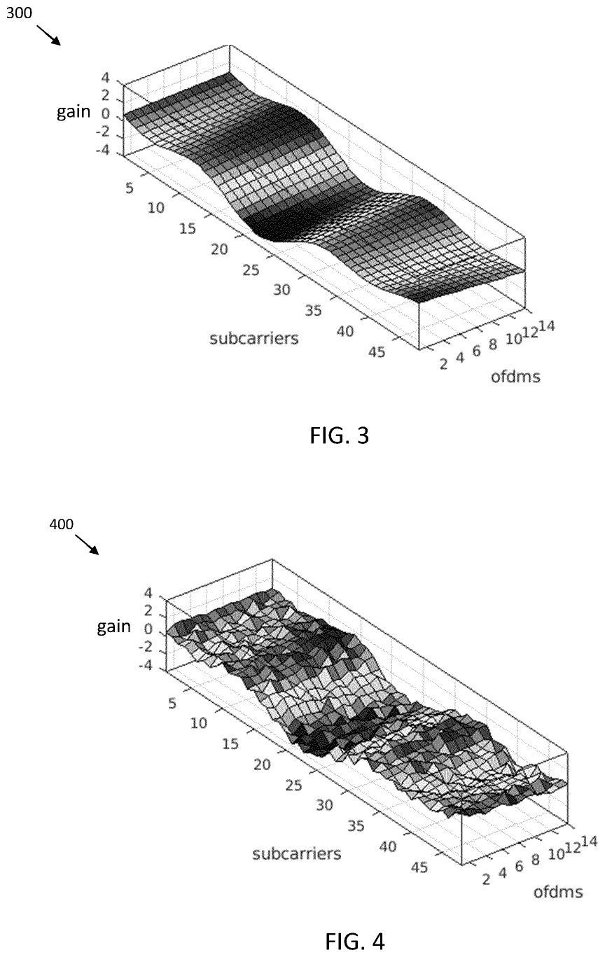

FIGS. 3 and 4 illustrate two different realizations 300, 400 of radio propagation channels in a multi-carrier system. It is noted that the channel gain changes over both time (OFDM symbols—ofdms) and frequency (subcarriers). Hence, the channel realization at a given pilot RE will be different from the channel realization at a data RE some distance away from the pilot RE. The example channel realization 300 is also associated with a higher signal to noise ratio (SNR) compared to the channel realization 400, which should also be accounted for when performing the channel estimation. In order to arrive at a channel estimate for a data RE in-between two or more pilot REs, some form of estimation is necessary.

Least-squares (LS) methods have been proposed for channel estimation. An LS method estimates a (complex) channel gain matrix Ĥ at pilot REs (pilot positions) by solving the following distance minimization problem

$$\hat{H} = arg {min}_{H} {‖ y - Hx ‖}_{2}$$

where y and x are received and transmitted pilot signals, respectively, where x is often known at least in part. After estimating the complex channel gains of pilot REs, the channel realizations at data REs are estimated based on a straight-forward two-dimensional interpolation.

When conventional channel estimation methods such as least squares (LS), minimum mean-square error (MMSE) or linear MMSE (LMMSE) estimators are used to estimate the channel gains in data REs, they basically rely on a naive 2-D interpolation method, and it may therefore be hard to capture the complex pattern of many realistic radio propagation channel realizations. More importantly, as future networks tend to become more broadband, these traditional approaches cannot properly scale with the increased dimensions of channels over frequency and time domain.

In “Deep learning-based channel estimation”, IEEE Communications Letters 23.4 (2019): 652-655, Soltani, Mehran, et al. proposed a two-step channel estimation method using deep learning based on image super resolution techniques. The channel realization is here seen as an image where each RE represents a pixel. Given the input of pilot channel measurement in pilot REs, i.e., a sub-set of the image pixels, the super resolution network fills in the channels in data REs, and further polishes the values using an image restoration network. This work trained neural networks by using a conventional Euclidean-based L2 norm function defined by the pixel-wise mean square-errors between the true and estimated channels.

It is unsure whether image super resolution techniques such as that proposed by Soltani, and Mehran will be able to perform accurate channel estimation for realistic radio propagation channels because the objective function (or loss function) used in training the machine learning networks is based on a conventional Euclidean-based L2 norm defined by the mean square-errors between the perfect and the estimated channels. Note that the pixel-wise loss function is good at capturing low-level details in an image, but fails to learn high-level channel patterns characterized by, e.g., delay and Doppler, which is essential for channel estimation in time-varying frequency-selective channels.

Pilot symbols received from a far-end transceiver over a bi-directional radio propagation channel can also be utilized to estimate a channel realization valid for transmission to the far-end transceiver. For instance, pilot symbols received over an uplink radio channel can be used to optimize MIMO precoding for transmission on a corresponding reciprocal downlink channel. However, some performance degradation is often inevitable due to channel ageing between channel acquisition in uplink and precoding design in downlink, caused by the dynamic nature of most wireless channels.

As illustrated in FIG. 15, channel prediction may for example be conducted in the following way. The radio channel responses at one or more pilot symbols 1510 transmitted on an uplink between two radio transceivers (such as a wireless device 130, 140 and an access point 110, 120) is first observed. Then, based on the channel characteristics observed at past uplink pilot symbol transmissions 1510, the radio propagation channel for one or more resource blocks at a future time instant 1520 is predicted. This prediction can be used for adapting transmission at a time slot after the time the pilot symbols were received. Herein, a communication resource which follows some other communication resource in time, i.e., which takes place at a later point in time, is denoted as being contiguous in time to the other communication resource. Channel prediction has been studied previously, mainly using classical signal processing approaches such as Wiener filters and Kalman filters, for instance by Hwanjin Kim, et al, in “Massive MIMO channel prediction: Kalman filter vs. Machine learning,” IEEE Transactions on Communications, January 2021. Most of the previously proposed methods for radio channel prediction uses a model to describe the radio channel behavior, which model is parameterized by one or more model parameters. These model parameters are then predicted based on input data such as current channel realizations inferred from pilot symbol transmission.

It is notoriously difficult to accurately model spatial and temporal dynamics of wireless channels. Therefore, most traditional model-based channel prediction approaches are limited in performance by the accuracy of the model used for the prediction.

Generative adversarial networks (GAN) are machine learning methods in which two neural networks (or other machine learning structures) compete against each other in a zero-sum or minimax game. One neural network, G, is the generative model, and the other neural network, D, is the discriminative model. G tries to learn the data distribution with random input vectors as the latent space of G while D estimates the probability that the sample came from the training data or from the true data distribution rather than the data generated by G. This can be thought of as a counterfeiter model (G) that tries to make fake data and a discriminative model (D) that tries to detect the fakes. For instance, the generator tries to create a fake image while the discriminator tries to classify generated images as fake or true images. After the training, the generator can often create a random realistic image that is almost indistinguishable from the target data-a perfect fake. GAN structures have been applied with advantage in image processing, and have recently also been proposed for use in radio propagation channel estimation.

A conditional GAN (cGAN) structure is an extension of a GAN structure where both generator and discriminator modules use side information or labels (conditioning information) with or without random vectors in the latent space, in order to generate images satisfying certain conditions or properties. In other words, the generator generates an output (e.g., image) based on input information (e.g., an input image), and the discriminator determines if the generator output is fake or not based on the same input information.

In the GAN literature, the generative part may also be referred to as the predictor, while the discriminative part may be referred to as an adversarial learner, or just a learner, providing an adversarial loss used to train the generator. These terms will also be used herein from time to time.

There is a performance-to-overhead trade-off between channel estimation performance and pilot symbol overhead. In order to minimize the pilot overhead, Hu, Tianyu, et al. proposed in “Channel Estimation Enhancement with Generative Adversarial Networks.” IEEE Transactions on Cognitive Communications and Networking (2020), to train a conditional GAN structure to generate fake received pilot sequences that capture the same distribution of true received pilot sequences. GAN is used as a supplementary method for improving the performance of the traditional channel estimation methods by generating fake pilot sequences.

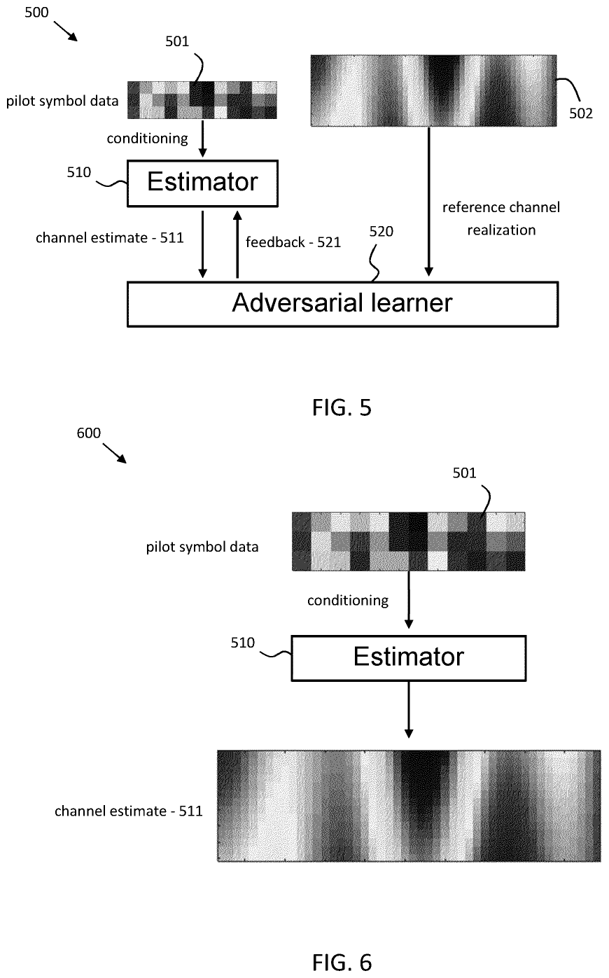

The present disclosure presents techniques in which cGANs are used for channel estimation, including estimation of both current and future channel realizations, i.e., channel prediction. FIG. 5 illustrates the general concept 500. The channel realization can again be thought of as an image, where each pixel represents the channel realization compromised of real and imaginary parts or equivalently amplitude and phase of the channel response at an RE. Pilot symbol transmission provides information about some of the pixels in the image—the pilot symbol data, but not all the pixels making up the image, and it is desired to obtain an estimate of the full image, representing the complete radio propagation channel.

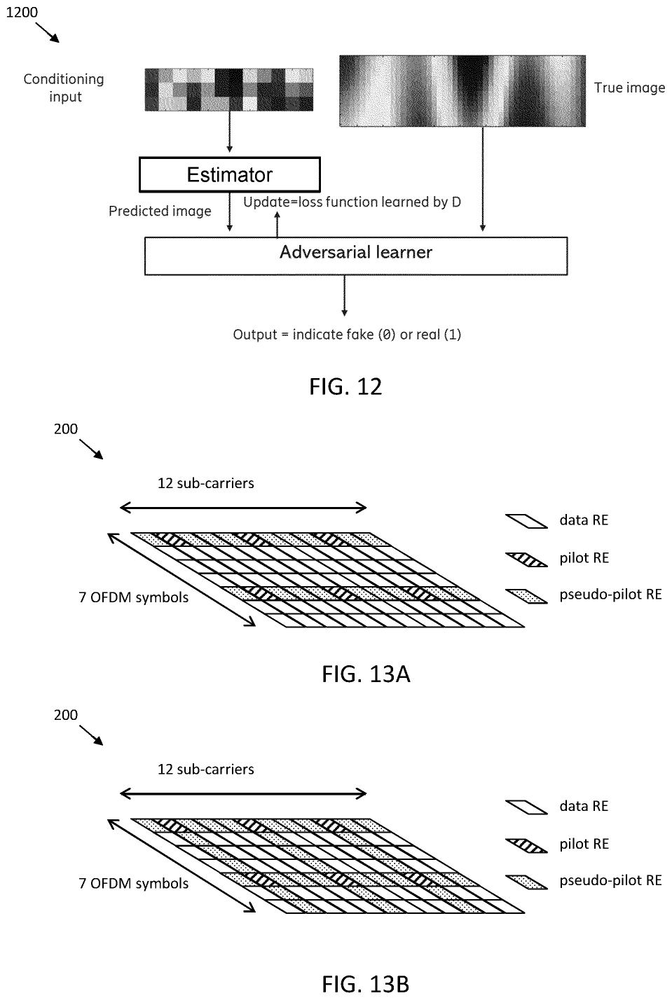

FIG. 12 illustrates another example 1200 of the proposed technique. The estimator receives conditioning input obtained from pilot symbol transmission over the radio propagation channel. A predicted image and a true image are input to the adversarial learner, which feeds back a loss function value to the estimator part. The output from the adversarial learner is a binary value indicating if the predicted image was deemed fake or real.

Generally, other forms of data can be added to the conditioning input. Such forms of data may comprise, e.g., an estimated motion velocity an/or direction of the wireless device relative to the access point, whether the radio propagation channel between wireless device and access point is in line-of-sight (LOS) or non-line-of-sight (NLOS), an estimated signal-to-noise ratio (SNR), and/or an estimated signal to interference ratio (SIR).

With reference to FIG. 15, a particularly interesting form of data which can be added to the conditioning input is a prediction time T. This prediction time T is a delay between the radio propagation channel realization to be estimated (i.e., predicted) and a reference time instant, such as the time instant where the last pilot symbols were received. In FIG. 15, the time Dt between pilot symbol transmissions 1510 may, e.g., be 5 ms and the frequency spacing Df between pilot symbol transmissions may, e.g., be 60 KHz. The prediction horizon T to radio channel realizations 1520 to be predicted may be on the order of the pilot symbol spacing, i.e., about 5 ms.

The radio propagation channel state hₖ at some slot k can by represented by the values of channel responses on the time-frequency grid of size equal T×F, where T is the number of OFDM symbols and F is the number of total subcarriers. Time series of states hₖ from data measurement provides valuable information about the underlying channel dynamics of a wireless communication system. In the absence of an accurate model, the time-varying radio channel can be described by using an alternative description of its dynamical system in a state-evolution function with memory, where

$${h}_{k + 1} = f ( {h}_{k} , {h}_{k - 1} , … , {h}_{k - m + 1} )$$

where m is the memory size. The exact evolution function ƒ (·) is generally unknown and nonlinear. However, the temporal evolution of the radio channel can be successfully predicted through function approximation to the evolution function, as will be shown herein.

The generative part 510 of the GAN structure 500 is used as channel estimator and/or as channel predictor. The generative part is conditioned, i.e., fed, by pilot symbol data 501, and trained to output channel estimates 511 based on the pilot symbol data. The discriminative part 520 of the GAN structure 500 is used as adversarial discriminator part. This adversarial discriminator part is trained to detect “fake” channel realizations, i.e., channel realizations which do not appear realistic, based on reference channel realizations that correspond to the pilot symbol data 501. The discriminator 520 outputs an update signal 521 used to train the generative part 510.

As noted above, a channel realization such as the reference channel realization 502 illustrated in FIG. 5, may be seen as a grey-scale image, where each “pixel” corresponds to an RE, and where some of the REs (the pilot REs) are associated with a-priori known data. The channel estimator only sees the pilot symbol data. By conditioning the generative part of the GAN structure on the pilot symbol data (a sub-set of the pixels in the “image”), the generative part is trained to output an “image” in an attempt to fool the discriminator that the output is indeed a real channel realization. The discriminative part, on the other hand, is trained to scrutinize the “images” generated by the generative part in an attempt to detect which ones that are fake, and which ones that actually correspond to real channel realizations.

According to an example, after training of the GAN structure, the generative part 510 can be extracted and used in a wireless communication system 100 as a channel estimator. FIG. 6 illustrates such a channel estimator 600, which has been extracted from a GAN structure following convergence of a training procedure. This channel estimator then accepts pilot symbol data 501 as conditioning input to the generative part (the estimator), which then generates an estimate of the complete image, i.e., an estimate of the radio propagation channel realization at all the REs, including both pilot symbol REs and data REs. It is noted that the channel estimates for the pilot symbol REs may not necessarily correspond exactly to the conditioning data 501, since the conditioning data may be corrupted by noise and other forms of distortion.

To summarize, in a training phase, a conditioning image is obtained from observed channel responses at pilot REs and used as input to the generative part of the GAN structure. The 2D input “image” is given by the noisy channel responses measured for the pilot REs. The generative part 510 then generates fake channel responses for all REs. The adversarial discriminator part, i.e., the discriminative part 520 of the GAN structure, takes as input the fake generated channels at all the resource elements from the generative part and outputs a binary value indicative of if the output from the generative part is a constructed (fake) channel representation or represents a true channel realization. Optionally, the generative part and the discriminative part of the GAN structure are trained in sequence, such that a first part is held fixed while the second part is updated, whereupon the second part is then held fixed while the first part is updated. This may improve on the convergence rate during training. According to some further aspects, the channel response is estimated as a gain-normalized channel response. This means that variations in radio propagation channel path loss is compensated for prior to performing the herein proposed methods.

The generator part and the discriminator part of the GAN structure are trained such that the generator progressively becomes better at creating images that look true channel images, while the discriminator becomes better at classifying them as fake or true. The process is repeated until some convergence criterion is met. Once the GAN structure has been trained, it can be deployed and used for channel estimation in a real world wireless communication system. The channel estimators derived in this manner can be used for channel estimation at both uplink (UL) and downlink (DL). The method can also be used for channel prediction in a straight forward manner, simply by feeding the GAN structure during training by reference channel realization data obtained at a delay T relative to the pilot symbol data. It is appreciated that the GAN structure can be trained for a plurality of different prediction delays T, such that a suitable GAN structure can be selected based on a frame format of communication in a wireless access network.

A suitable metric for use as loss function during training is a cross entropy loss function. The loss function used to train the generative part should of course quantify how well the generative part was able to trick the adversarial discriminator part into thinking that the channel estimate was in fact a real radio propagation channel. Intuitively, if the generative part is performing well, the discriminative part will classify the fake images as real. The loss function for the discriminative part quantifies how well the adversarial discriminator part is able to distinguish real radio propagation channels from fakes. Each of the networks is trained separately and therefore two different optimizers are used for the discriminator and the generator. When the generator is trained, the loss function is defined for fake images with the label of 1s at the discriminator output. When the discriminator is trained, the loss function is defined for fake images with the label of 0s and for true images with the label of 1s. An example cross-entropy loss function may be formulated as

$$- E [ {y}_{true} * log ( {y}_{predicted} ) + ( 1 - {y}_{true} ) * log ( 1 - {y}_{predicted} ) ]$$

where γₜᵣᵤₑ is the true label, and γ_{predicted} is the predicted output by the discriminator.

When used in multi-antenna systems with no spatial correlation, the generative part models can be developed and deployed independent of spatial domains. However, when multi-antenna channels exhibit spatial correlation, it may be advantageous to train one model for channel estimation of multiple spatial domains, in order to better exploit the spatial correlation properties.

At least two different approaches for training a generative part can be envisioned. First, offline training based on simulated channels, and second, on-line training in test-beds or in real-world systems. In offline training based on simulated channels, “true” radio propagation channel realizations are generated by a channel model. In online training, actual radio transmission data is used to perform training of the GAN structure. The two can also be advantageously combined, such that a GAN structure is initially trained off-line based on simulated channels or based on real channels obtained from actual radio transmission, followed by a more fine-grained training online based on real channels.

Radio channel prediction using GAN structures can be performed in various domains such as channel responses of elements in a MIMO channel matrix and its eigen-vector space (or precoding matrix index (PMI).

For instance, in 3GPP channel reciprocity-based TDD systems, channel estimates based on pilot symbol transmissions on uplink such as sounding reference signals (SRS) can be used to design beamforming vectors to be used for transmission on the downlink. The input matrix to the GAN structure can constructed based on the past uplink SRSs. The reference channel realizations used for training the GAN structure can be defined from the next time slots in downlink in the same way.

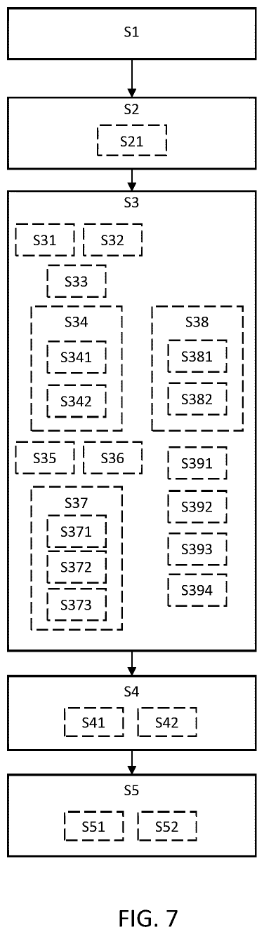

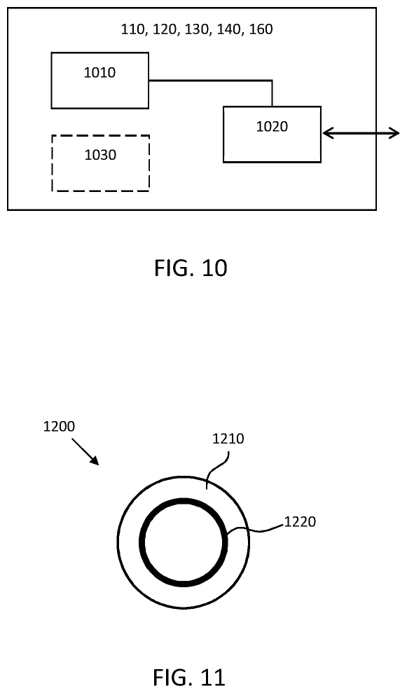

In practice, because of RF impairments at the transceivers involved in transmission of pilot symbols, the received channel knowledge is in general non-coherent, since it may be corrupted by phase jumps which occur at each individual uplink sounding slot. Because the phase jump impairments have no impact on the eigenvectors of the radio channel which are used as the downlink beamforming weights, a GAN-based channel prediction can be used to predict the channel eigenvectors from non-coherent pilot symbol data. In this case, the input matrix is given by principal eigenvectors of each sub-band in the past time slots and the output matrix comprises principal eigenvectors of each sub-band for the next time slot or slots. FIG. 7 is a flow chart illustrating several aspects of the herein proposed techniques described as methods. The methods disclosed herein are advantageously implemented in network nodes and/or in wireless devices, as will be discussed in more detail below in connection to FIG. 10. The different steps of the disclosed methods may be implemented at the access point, at the wireless device, at a remote server, or distributed over more than one processing circuit.

With reference also to FIGS. 1-6 discussed above, FIG. 7 illustrates a method for estimation of a radio propagation channel realization 300, 400, performed in a wireless communication system 100 comprising one or more access points 110, 120 and one or more wireless devices 130, 140.

The method comprises obtaining S1 a GAN structure 500, wherein the GAN structure comprises a generative part 510 and a discriminative part 520, as exemplified above in FIG. 5. The two parts 510, 520 of the GAN structure are advantageously implemented as neural networks, although other types of machine learning structures may also be used. For instance, the discriminator part may be advantageously realized based on a random forest structure. Random forests or random decision forests is an ensemble learning method for classification, regression and other tasks that operates by constructing a multitude of decision trees at training time. For classification tasks, the output of the random forest is the class selected by most trees. Generally, a GAN structure is a specification detailing the different parts in terms of, e.g., neural network depth and connections. The GAN structure is in itself not capable of performing any useful functions since it is just a shell. However, functionality may be obtained by training the GAN structure using a training procedure and a training data set, which will be discussed in more detail below. Various types of neural networks can be considered in both the generative part as well as the discriminative part of the GAN structure, e.g., convolutional neural networks (CNN), deep stacking networks, recurrent neural networks, and radial basis function networks, just to name a few.

The method comprises configuring S2 the GAN structure 500 as a conditioned GAN structure, where the generative part 510 is arranged to be conditioned by pilot symbol data comprising radio propagation channel data obtained from pilot symbol transmissions over the radio propagation channel. The pilot symbol transmissions S21 optionally comprise transmission of 3GPP Demodulation Reference Signal (DMRS) resource elements (RE) in an OFDM based system and/or 3GPP sounding reference signals (SRS).

The GAN structures used herein comprises a generative part 510 with an input port for receiving pilot symbol data 501. The pilot symbol data may, e.g., be in the form of a matrix or vector where each element is representative of a complex gain for a given subcarrier frequency and for a given time slot. The complex gain can be represented by its real and imaginary parts or its amplitude and phase, as well known in the art. The pilot symbol data can be seen as a sparse sampling of the denser radio propagation channel. In a sense, if the radio propagation channel matrix is seen like an image, then the pilot symbol data can be thought of as the image seen through a mask, possibly also corrupted by noise. The generative part 510 has another input port for receiving feedback 521 from the discriminator part. This feedback is representative of a loss function for the generator, which is learned by the discriminator. The discriminator may of course also provide an output which indicates if the current output from the estimator is considered a true channel realization by the discriminator part, or a fake channel realization, as shown in FIG. 12. This input port is mainly used during the training phase. The generative part 510 has one output port, through which a channel estimate is output to the discriminative part 520. The channel estimate is generally in the form of a matrix or vector with complex elements indicative of complex channel gains for the different subcarriers and time slots of the radio propagation channel to be estimated. The discriminative part 520, also known as the adversarial discriminator part or adversarial learner in the GAN literature has two input ports and one output port. A first input port is connected to the generative part 510 of the GAN structure 500 and arranged to receive the channel estimates 511. A second input port is arranged to receive reference channel realizations. The discriminative part 520 is arranged to output feedback data 521 via the output port back to the generative part, which feedback data indicates if the channel estimate output from the generative part was deemed a true channel realization or a fake. GAN structures are generally known and will therefore not be discussed in more detail herein.

The method further comprises training S3 the GAN structure 500 by conditioning the generative part 510 on the pilot symbol data and feeding a corresponding output 511 from the generative part 510 to the discriminative part 520 together with reference channel realization data 502 corresponding to the pilot symbol data.

Now, let n_{sym} and n_{sc} denote the number of symbols and subcarriers in a frame, respectively. Then, the received signal γ_{i,j} at the subcarrier i=1, . . . , n_{sc} in symbol j=1, . . . , n_{sym}, denoted by RE_{i,j}, can be represented by

$${y}_{i , j} = {h}_{i , j} {s}_{i , j} + {n}_{i , j}$$

where h_{i,j} denotes the channel response, s_{i,j} denotes data or pilot, and n_{i,j} is noise.

Let I_{data} and Iₚᵢₗₒₜ denote the set of data REs and pilot REs, respectively, in a given frame. At the receiver side, a receiver receives the transmitted pilot symbols at the pilot REs, RE_{i,j} for i, j∈Iₚᵢₗₒₜ and observe noisy channel responses h_{i,j} for i, j∈Iₚᵢₗₒₜ through a simple denoising operation or channel estimation.

2D images can be obtained from a time-frequency pilot grid within a frame. These pilot images will be used as the conditional input in an adversarial training. In a similar way, 2D images of true channel responses h_{i,j} on all the REs including data and pilot REs, i.e., channel responses h_{i,j} for i, j∈(I_{data} U Iₚᵢₗₒₜ). This image will be used as a ground truth image for defining adversarial loss.

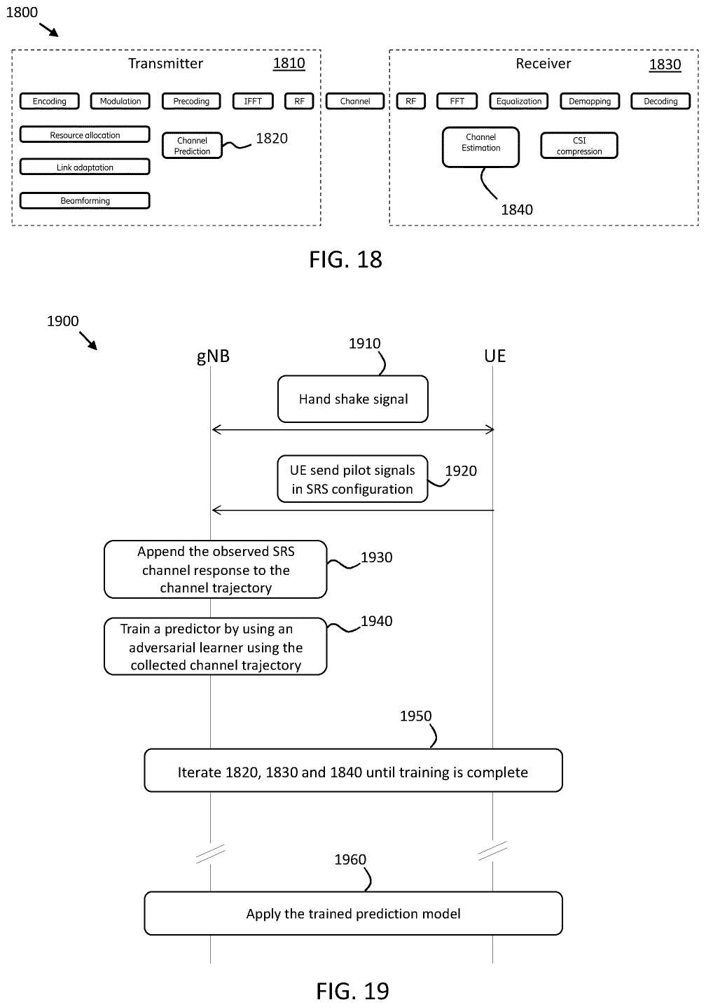

During an example training phase, a conditioning image is obtained from observed channel responses at pilot REs and used as input to the generative part 510. The 2D input image is given by the noisy channel responses h_{i,j} for i, j∈Iₚᵢₗₒₜ obtained from the received pilot signals γ_{i,j} for i, j∈Iₚᵢₗₒₜ. The generative part 510 then generates fake channel responses at all resource elements (REs), consisting of data and pilot REs. This output from the generative part 510 is received as input by the discriminative part 520, which then outputs feedback data to the generative part indicative of if the output was deemed true or fake. The channel responses generated by the generative part 510 may be concurrent with the conditioning image or contiguous in time to the conditioning image. This will be discussed in more detail below in connection to, e.g., FIG. 18.

The generative part 510 and the discriminator part 520 are trained such that the generative part 510 progressively becomes better at creating images that look true channel images (current or future), while the discriminator part 520 becomes better at classifying them as fake or true.

Cross entropy may be advantageously used as the loss functions for each of the generative part and the discriminator part, as discussed above. The generative parts' loss quantifies how well it was able to trick the discriminator part. Intuitively, if the generative part is performing well, the discriminator part will classify the fake images as real. Meanwhile, the discriminator part loss function quantifies how well the discriminator part is able to distinguish real images from fakes. Each of the machine learning networks of the GAN structure 500 is trained separately and therefore two different optimizers are used for the discriminator and the generator. When used in multi-antenna systems with no spatial correlation, the generative part models can be developed and deployed independent of spatial domains. When multi-antenna channels exhibit spatial correlation, we can train one model for channel estimations of multiple spatial domains to exploit the spatial correlation properties.

The training S31 is preferably performed until a termination criterion, for example associated with a capability of the generative part 510 to generate an output classified as a true channel realization by the discriminative part 520, is met. For instance, the termination criterion can be a threshold on the loss function value achieved during iterations in the training phase. The termination criterion may also be a weighted sum of a measure of the ability of the generative part 510 to generate a channel estimate which is deemed to be a true channel realization by the discriminative part, and a measure of the ability of the discriminator part to identify true channel realizations in a set of channel realizations that also comprise fake channel realizations. The training part can also be considered completed after a pre-determined number of iterations have been completed.

The method optionally also comprises performing S32 an offline training procedure comprising generating the pilot symbol data and the reference channel realization data by computer simulation of a radio propagation channel model. The radio propagation channel model may, e.g., comprise any of a 3GPP TDL model, a 3GPP CDL model, and a 3GPP SCM model. Offline training has the advantage that the channel realizations used to train the GAN structure are synthetic, i.e., full ground truth is available. Advantageously, the method may also comprise performing S33 an additional online training procedure involving pilot symbol transmissions over a radio propagation channel between an access point 110, 120 and a wireless device 130, 140 in the wireless communication system 100. This additional online training procedure optionally comprises a transfer learning method and/or a meta learning method. Transfer learning is a relatively well-known machine learning method where a model developed for a task is reused as the starting point for a model on a second task. It is a popular approach in deep learning where pre-trained models are used as the starting point on computer vision and natural language processing tasks given the vast compute and time resources required to develop neural network models on these problems and from the huge jumps in skill that they provide on related problems. Meta-learning in machine learning refers to learning algorithms that learn from other learning algorithms. Most commonly, this means the use of machine learning algorithms that learn how to best combine the predictions from other machine learning algorithms in the field of ensemble learning.

According to some aspects, the structure is re-trained periodically, and/or in response to some triggering event. For instance, the quality of the generated channel estimates can be monitored, and a re-training trigger signal can be generated when the channel estimate quality goes below some threshold. The re-training may comprise a complete reset of the structure or an initialization based on the current GAN structure. It is of course also possible to start training a parallel structure while using a previously trained structure, and then active the new structure as it has converged. This way channel estimates will be obtained also during training of the new structure, since the old structure is not decommissioned until the new structure has reached sufficient maturity.

Following training, a channel estimator can be extracted S4 from the GAN structure 500 as the generative part 510 of the GAN structure. Thus, allowing for estimating S5 a radio propagation channel realization by feeding pilot symbol data to the channel estimator.

In an example execution phase, a transmitter sends pilot signals sₚ at pilot REs, RE_{i,j} for i, j∈Iₚᵢₗₒₜ, which are obtained, e.g., by combining pseudo-random sequences with frequency-domain code-division-multiplexing (CDM) weights. The receiver recovers the transmitted pilot signals at pilot REs through the reverse operations applied at the transmitter, in a known manner. The signal processing applied to received pilot symbols is preferably the same for both training and execution phases. The received pilot signals are represented above as

$${y}_{p} = {h}_{p} {s}_{p} + {n}_{p}$$

where sₚ is the pilot signal known at the receiver, nₚ is a noise term, and hₚ is a complex channel gain to be estimated.

Equivalently, the received pilot symbols can be further expressed by de-spreading with the transmit CDM and de-phasing with the transmit reference signal sequence as the decoded pilot signals

$${y}_{p} = {h}_{p} + {\dot{n}}_{p}$$

when the pilot symbols sₚ are known at the receiver and given by unit-power symbols such as 4-QAM symbols. At the receiver side, the trained generative part is then executed with the observed channels γₚ of pilot REs as an input 2D matrix. The generative part returns as an output a 2D matrix of channel estimates at all the REs.

According to some aspects, the method comprises performing S34 an online training procedure comprising extracting the pilot symbol data and the reference channel realization data from an ongoing communication in the wireless communication system 100. This way there is no additional pilot symbol overhead introduced into the training. Furthermore, since the training is based on ongoing communication, the GAN structure can be trained indefinitely, i.e., also during use for channel estimation. This means that the GAN structure will be able to adapt to changes in communication conditions, which is an advantage. I.e., if the overall behaviour of the channel changes over time, the generator part 510 will learn how to generate channel estimates which account for the new channel behaviour, and the discriminator part will become better at detecting when the channel estimates from the generative part are not realistic enough, given the new channel behaviour. The ongoing communication in the wireless communication system 100 optionally comprises a transmission S341 of pilot-weaved frames comprising only known information symbols. This type of transmission is of course associated with significant overhead since the frame comprises only pilot symbols.

However, transmission of this type of frame represents valuable training data which can be used to initiate the GAN training in the online training mode, and/or to verify that the GAN structure still performs with an acceptable accuracy. The ongoing communication in the wireless communication system 100 may furthermore comprise a transmission S342 of interleaved frames comprising a predetermined pilot symbol pattern.

The herein disclosed methods may furthermore comprise training S35 the GAN structure 500 using a respective cross entropy loss function for each of the generative part 510 and the discriminative part 520. Cross-entropy loss functions are generally known and will therefore not be discussed in more detail herein. Other example GAN loss functions that can be contemplated comprise the Least Squares GAN loss function and the Wasserstein GAN loss function. The methods may also comprise training S36 the GAN structure 500 using a loss function comprising an adversarial loss and a Euclidean distance between the output from the generative part 510 and the corresponding reference channel realization data, which allows faster learning of mapping the conditional pilot images to reference channel images in a conditional GAN setup.

As discussed above, the GAN structure comprises two models: a discriminator model and a generator model, which may both be realized as neural networks, or by some other form of machine learning structure. The discriminator is trained directly on real and generated images and is responsible for classifying images as real or fake (generated). The generator is not trained directly and instead is trained via the discriminator model. Specifically, the discriminator is learned to provide the loss function for the generator. The two models compete in a two-player game, where simultaneous improvements are made to both generator and discriminator models that compete. In a GAN, equilibrium between generator and discriminator loss is sought. A common loss function for the discriminator part is a cross-entropy loss function.

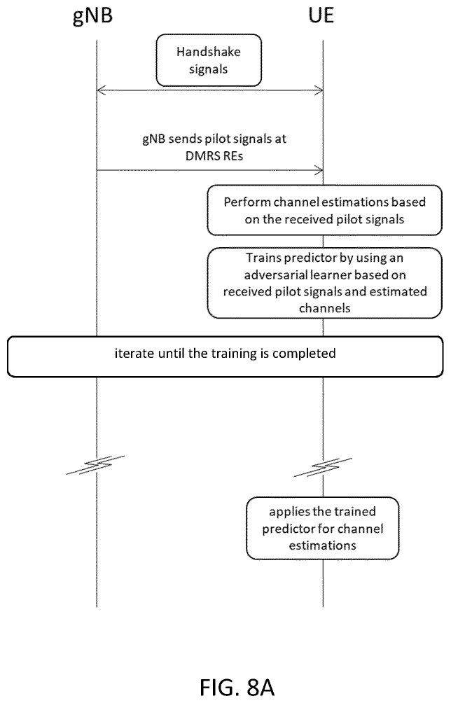

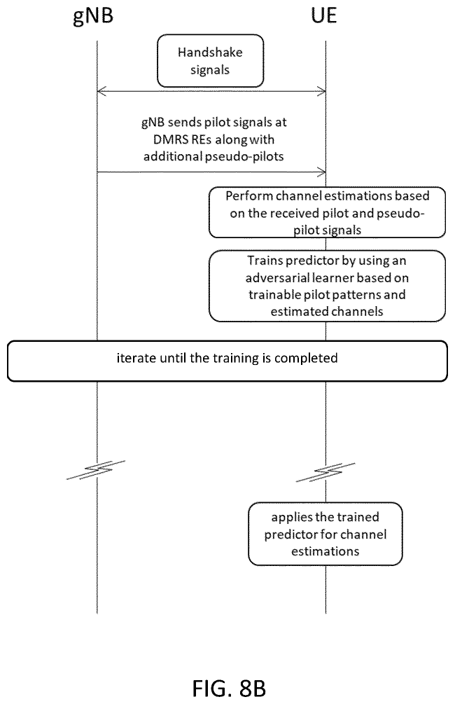

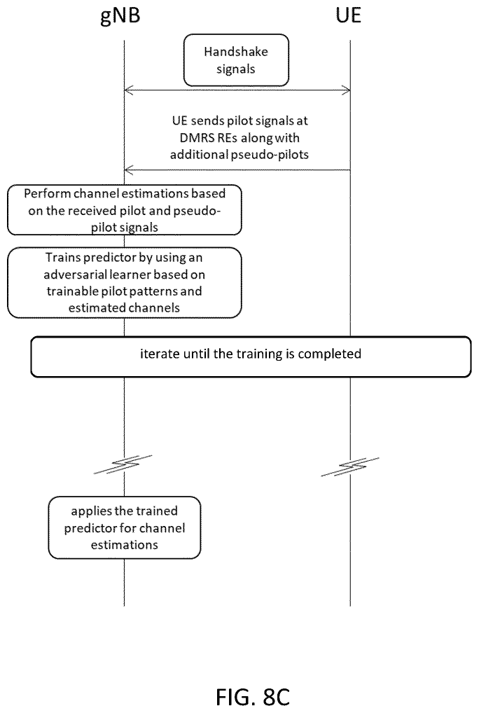

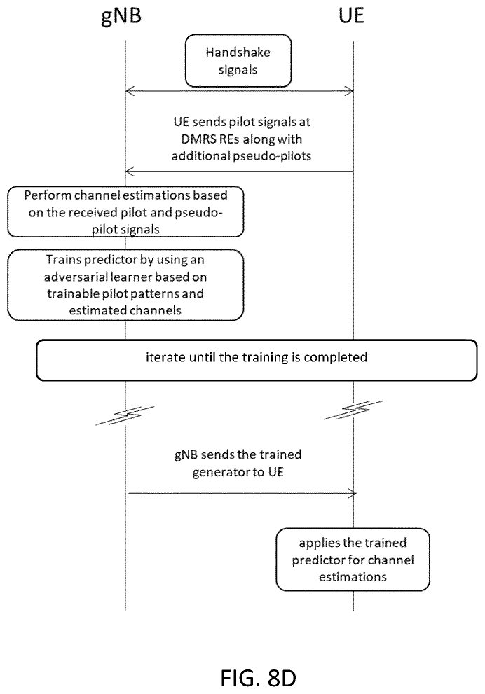

FIGS. 8A-D illustrate examples of the herein discussed methods, implemented in a wireless communication system 100 like that discussed above in connection to FIG. 1. An access point 110, 120 is here referred to as a gNB, while a wireless device 130, 140 is referred to as user equipment (UE). The generative part 510 of the GAN structure 500 is referred to as a predictor, in line with terminology that is common in the GAN literature, and the discriminator part 520 is referred to as a learner. It is generally appreciated that the methods discussed herein can be performed in one of the access points 110, 120 or in one of the wireless devices 130, 140, or partly in the access point and partly in the wireless device. Parts or all of the methods may also be performed in a remote server 160. The wireless communication system 100 is advantageously an orthogonal frequency division multiplexed, OFDM, based system, such as a 3GPP 5G or 6G system.

In all of FIGS. 8A-D, the process starts by a handshaking routine, where the UE and the gNB exchange configuration data allowing the GAN structure to be trained and used. This handshake procedure may, e.g., comprise agreeing on a particular type of pilot symbol transmission scheme, and may optionally also comprise exchange of details related to the particular GAN structure to be trained and used for channel estimation. The handshake procedure may be triggered upon the wireless device powering up and associating itself with the operator network, or it can be triggered on handover, or by some other triggering condition, such as a detection of reduced quality radio propagation channel estimates.

In FIG. 8A, the UE performs both training of the GAN structure and uses the predictor for channel estimation. Thus, after handshaking, the gNB transmits pilot symbols to the UE, whereupon the UE performs channel estimation based on the received pilot signals, and also trains the predictor in the GAN structure using the learner structure and the pilot symbol transmissions. This training, i.e., the transmission of pilot symbols from the gNB to the UE followed by updating of the generative part 510 and the discriminative part 520, is then iterated until a convergence criterion is reached. Following convergence, the predictor part, i.e., the generative part 510, is extracted from the GAN structure 500 and used to estimate the radio propagation channel realizations during communication over a radio link between the gNB and the UE.

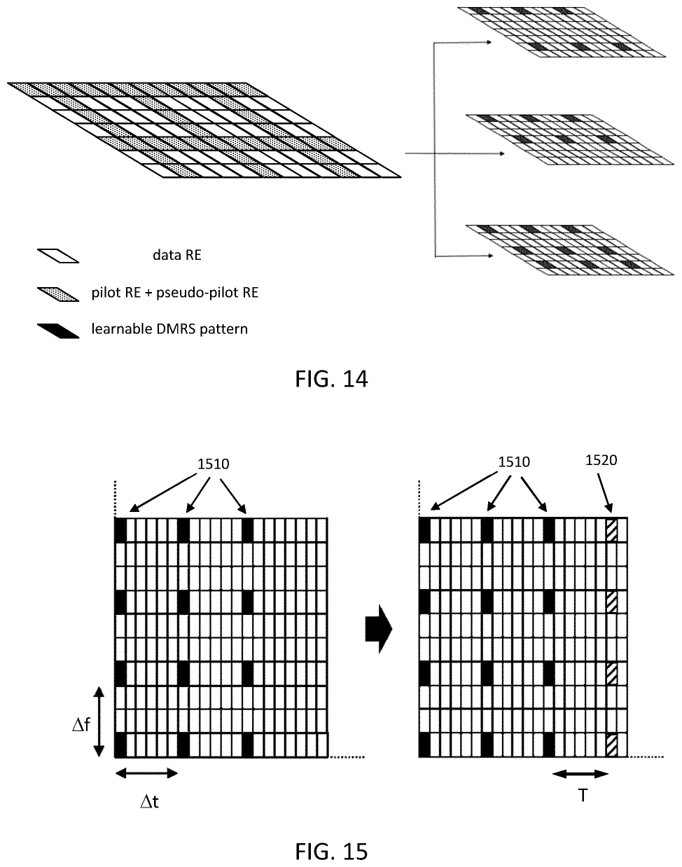

In FIG. 8B, the gNB also sends pilot-waved frames with additional pseudo-pilot symbols. A pseudo-pilot symbol is an additional transmission from the gNB having an a-priori known structure. A pseudo-pilot transmission may, for instance, be a reduced order QAM modulated information symbol which can be detected with a very low probability of error, or some other form of a-priori known structure symbol. The remainder of the procedure illustrated in FIG. 8B is the same as that discussed above in connection to FIG. 8A. Examples of frames comprising pseudo-pilot symbols are shown in FIGS. 13A and 13B. The pseudo-pilot pattern may, e.g., be used to provide more than one DMRS pattern in a single frame, as illustrated in FIG. 14, which improves on the training performance. In other words, one or more pseudo-pilot symbols can be inserted into a frame in order to mimic more than one DMRS pattern with a single frame. The GAN structure can then be trained for multiple DMRS patterns faster.

FIG. 8C shows another example realization of the proposed method, where the training and the channel estimation is instead performed at the gNB side. In this case, the UE instead sends the pilot symbols, possibly along with additional pseudo-pilot symbols. The gNB receives the pilot symbol transmission from the UE and trains the GAN structure as discussed above. Once the GAN structure is deemed sufficiently trained, the predictor part can be used by the gNB for channel estimation.

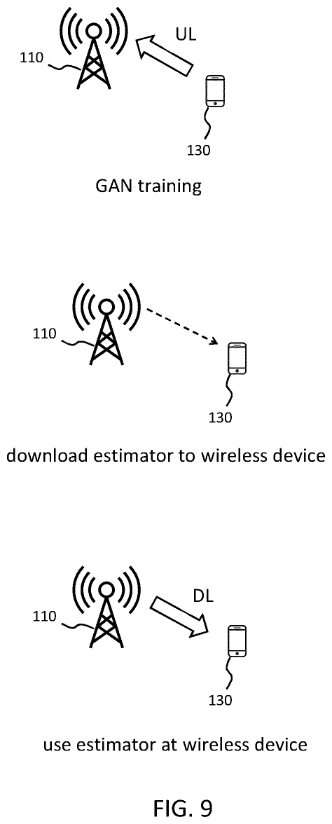

In FIG. 8D, the radio propagation channel between UE and gNB is considered reciprocal. This means that the channel can be estimated at the gNB side, as in FIG. 8C, and the predictor part is then transmitted from the gNB to the UE, whereupon the UE can use the predictor structure for channel estimation. FIG. 9 shows the implementation more schematically. The GAN is first trained based on uplink transmission of pilot symbols from the wireless device 130 to the access point 110. Note that the actual data processing can take place at the network node, or in some remote server, like the network node 160 illustrated in FIG. 1. The channel estimator is the extracted from the GAN structure as the generative part and downloaded to the wireless device 130, whereupon the wireless device 130 can use the estimator for channel estimation.

In light of the illustrations in FIGS. 8A-D, it is appreciated that the methods disclosed herein may comprise training S37 the GAN structure 500 at an access point 110, 120 of the wireless communication system 100 based on communication over an uplink, UL, from a first wireless device 130, 140 to the access point, and transmitting the channel estimator to the first wireless device upon the generative part 510 of the GAN structure reaching a predetermined convergence criterion.

Interestingly, the herein disclosed methods may also comprise downloading S371 the discriminative part 520 to the first wireless device and using the discriminative part 520 in a fault detection structure at the wireless device. Basically, as long as the overall behaviour of the radio propagation channel remains aligned with the behaviour it had during training of the GAN structure, then the discriminator part would identify most of the outputs from the generative part as true channel realizations. However, if the radio propagation channel changes its behaviour in some fundamental manner, then the discriminator part may well start to declare that even frames comprising a dense pattern of pilot symbols is a fake channel realization. According to a related aspect the method may comprise triggering S372 a fault condition in case the discriminative part 520 indicates that an estimated channel realization is not a true channel realization. The methods may also comprise triggering S373 generation of an alarm message to an operations and maintenance node in the wireless communication system in case the discriminative part 520 indicates that an estimated channel realization is not a true channel realization.

According to some aspects, the method may comprise transmitting S38 a channel estimator trained at a first access point to the wireless device in response to the wireless device performing a handover procedure for service by the first access point. It is appreciated that the overall radio propagation conditions in one cell may differ from the radio propagation conditions in another cell. This means that a GAN structure 500 trained in one cell may not be efficient in estimating the radio propagation channel realizations in another cell. To provide a better tailored channel estimator, the method may comprise training cell-specific GAN structures, which can then be downloaded to a wireless device entering the cell. The GAN structures downloaded to the wireless device as it enters a new cell. The method optionally also comprises transmitting S381 a GAN channel estimator trained based on communication in a geographical area to the wireless device in response to the wireless device entering the geographical area. The transmitted GAN structures can of course also be refined by the particular wireless device using online training as discussed above.

According to further aspects, the method may comprise transmitting S382 a channel estimator to the wireless device, where the channel estimator has been trained based on communication involving a specific type of wireless device, where the wireless device is associated with the specific type of wireless device. This may be advantageous if the wireless device has some peculiarities, such as a special type of antenna system, which may have an effect on the overall radio propagation channel between transmitter and receiver.

The GAN structures discussed herein may as discussed above be used for estimating a current channel realization, e.g., channel realizations for resource blocks in-between received pilot symbols, i.e., time-aligned, or concurrent with the reception of the pilot symbols, or for predicting a future channel realization which is contiguous with the received pilot symbols in time, possibly also on a reverse direction radio link compared to the radio link over which the pilot symbols were received.

With continued reference to the flow chart in FIG. 7, in the concurrent channel estimation case, the method may comprise training S391 the GAN structure 500 by conditioning the generative part 510 on the pilot symbol data and feeding a corresponding output from the generative part 510 to the discriminative part 520 together with reference channel realization data which is concurrent with the pilot symbol data, and extracting S41 a channel estimator for estimating a current channel realization from the GAN structure 500. In this case, the reference channel realization data used to train the structure is a channel realization which is time-aligned with the pilot symbols. For instance, the reference channel realization data may be a channel realization for use in a receiver to decode symbols in-between the pilot symbols. I.e., the method may comprise processing S51 a radio transmission received by a network node from an access point 110, 120 or from a wireless device 130, 140 based on the estimated current radio propagation channel realization.

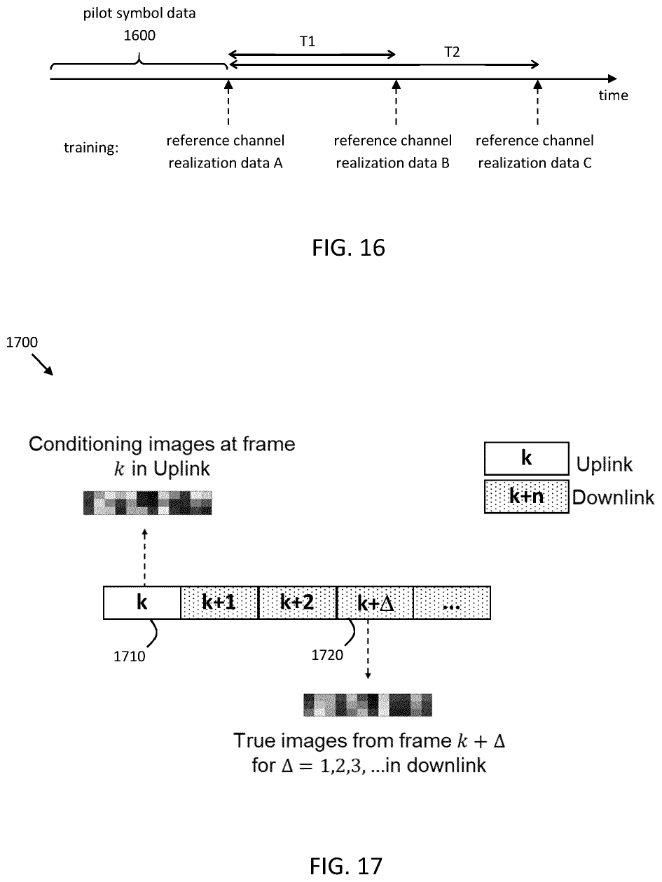

For the case of channel prediction, i.e., the estimation of a future radio propagation channel realization, the method advantageously comprises training S392 the GAN structure 500 by conditioning the generative part 510 on the pilot symbol data and feeding a corresponding output from the generative part 510 to the discriminative part 520 together with reference channel realization data contiguous in time to the pilot symbol data and extracting S42 a channel predictor for estimating a future channel realization from the GAN structure 500. The reference channel realization data which is contiguous in time to the pilot symbol data describes a channel realization at a point in time following after a time of transmission of the pilot symbol data, i.e., after transmission of the pilot symbol data by an amount of time T, as illustrated in, e.g., FIG. 16. Thus, it is realized that the GAN structures discussed herein can be utilized also for channel prediction, simply by training the GAN structure using reference channel realization data obtained for a point in time after the point in time of the pilot symbol data transmission.

FIG. 16 illustrates the general principles of training a GAN structure as a concurrent channel estimator versus training the GAN structure as a channel predictor, i.e., a channel estimator configured to estimate a radio propagation channel realization occurring sometime after transmission of the pilot symbols. Suppose pilot symbol data is available for a time period 1600 as indicated in FIG. 16. If the GAN structure is fed during training with reference channel realization data A that is concurrent with the pilot symbol data, then a channel estimator for estimating a radio propagation channel concurrent with the symbol data will be obtained. If instead the GAN structure is fed with reference channel realization data B that is contiguous with the pilot symbol data, at a delay of T1, then a channel predictor for estimating a channel realization occurring after a delay of T1 will be obtained. Likewise, if the GAN structure is fed during training with reference channel realization data C a channel predictor for a delay of T2 will be obtained.

Unlike the conventional model-based methods for channel prediction, the herein proposed machine learning based approaches are suitable for real-time applications because there is no need of any prior knowledge on the channel dynamics or iterative algorithms for estimating the dynamics of the radio propagation channel.

In one example embodiment 1700, illustrated in FIG. 17, pilot symbols are configured and transmitted by a UE in NR or LTE uplink as a sounding reference signal (SRS) and the corresponding images are obtained as conditioning images at a BS at a frame k 1710. The true images, i.e., the reference channel realization data contiguous in time to the pilot symbol data, are given by channel responses for a frame k+Δ 1720, for Δ=1, 2, 3 . . . in NR or LTE downlink, at the same REs that SRSs are transmitted. In this case, the pilots can be either non-precoded or precoded by the same precoding weight vector or matrix and the channel responses used for the images correspond to the channel coefficients seen by pilot symbols in the non-precoded or the precoded space. A GAN structure based predictor is trained based on the conditioning and true images and after the training, the predictor is used for channel estimation at future frames in NR or LTE downlink based on the SRSs at the current frame in NR or LTE uplink.

According to some aspects, a time delay T between the reference channel realization data used for training and the pilot symbol data corresponds to a delay between reception of pilot symbol data and a radio transmission. This way the channel prediction can be tailored to, e.g., a given frame structure with a certain timing between the reception of pilot symbols and the transmission of a radio signal in a direction reverse to the reception direction. The methods may also comprise training S393 the GAN structure 500 for a plurality of different time delays T between the pilot symbol data and the reference channel realization data. A suitable GAN structure trained using the correct time delay between pilot symbol reception and transmission can then be selected from the set of trained GAN structures.

FIG. 18 illustrates a radio transmitter 1810 and a radio receiver 1830 comprised in a system 1800 arranged for communication based on OFDM radio signals. The transmitter and the receiver are conventional OFDM devices. Notably, the transmitter 1810 comprises a channel prediction module 1820 where the channel prediction techniques discussed herein can be applied with advantage. The receiver 1830 also comprises a channel estimation module 1840 where the herein discussed channel estimation techniques can be applied with advantage. Thus, it is appreciated that the methods discussed herein may comprise processing S52 a radio transmission from any type of network node to an access point 110, 120 or to a wireless device 130, 140 based on the estimated future radio propagation channel realization. Likewise, the methods may also comprise processing S51 a radio transmission received by any type of network node from an access point 110, 120 or from a wireless device 130, 140 based on the estimated current radio propagation channel realization.

FIG. 19 is a signaling diagram 1900 which illustrates a channel prediction process according to an example of the herein disclosed methods. This example predictor is trained at the gNB side, i.e., the access point side, which collects SRS uplink channel responses. The channel prediction is then used for adaptation of the downlink transmission under a channel reciprocity assumption. The steps of the process are as follows:

1910: Handshake signals are exchanged between gNB and UE. The handshake signals may comprise information about parameters such as pilot symbol transmission, e.g., comb-factor, repetition factor and predictor training configuration.
1920: the gNB receives uplink channel response with SRS configuration.
1930: the gNB collects a trajectory of channel responses for the UE, i.e., pilot symbol data for one or more time slots.
1940: the gNB trains a channel predictor by using an adversarial learner as discussed above, based on the obtained pilot symbol data. The input to the GAN structure during training is the SRS channel response at length-k sequence of time slots in a trajectory. The output from the GAN structure is an SRS channel response at some predetermined future point in time.
1950: The process is iterated until the training is complete, i.e., until some predetermined convergence criterion is met, as discussed above.
1960: the gNB then applies the trained channel predictor(s) when predicting a downlink radio propagation channel realization for downlink transmission.

Some example implementations of the herein discussed GAN-based channel estimation and channel prediction methods will now be discussed. The temporal resolution of a wideband channel over a number of time slots can described by a channel process P that represents the underlying channel dynamics

$$P ( {h}_{k + 1} \vert {h}_{k} , {h}_{k - 1} , … , {h}_{k - m + 1} )$$

where hₖ ∈ [symbol] ^{T,F} denotes a channel state at slot k and m is the process memory. A purpose of a channel prediction method is, as discussed above, to predict a future channel state hₖ₊₁ given one or more previous channel states hₖ, hₖ₋₁, . . . , hₖ₋ₘ₊₁.

Three example implementations of the herein discussed channel prediction methods will now be discussed. All example implementations are channel prediction models parameterized by a parameter vector θ. The three examples are a baseline model denoted P_{θ}^{bs}, an image-completion model denoted by P_{θ}^{ic}, and a next-frame prediction model denoted by P_{θ}^{nf} that learns to predict the next channel state hₖ₊₁ given the channel states hₖ, hₖ₋₁, hₖ₋₂, hₖ₋₃ i.e., where m=4.

The pixel-wise metric l₁ is a widely accepted metric for defining loss function in image processing tasks. The same metric can also be used for quantifying prediction performance of a channel estimator. The corresponding loss function is defined based on mean absolute error over the pixels on the image, i.e.,

$${l}_{1} = \frac{1}{N \times T \times F} {\sum }_{n = 1}^{N} {\sum }_{t = 1}^{T} {\sum }_{f = 1}^{F} \vert {h}_{k + 1}^{n} ( t , f ) - {\hat{h}}_{k + 1}^{n} ( t , f ) \vert$$

where hₖ₊₁ⁿ(t, ƒ) and ĥₖ₊₁ⁿ(t, ƒ) are the true and predicted (t, ƒ) element (pixels) of the channel, respectively, N is the size of the data batch (in frames), T is the number of OFDM symbols and F is the number of subcarriers.

It has been realized that the U-Net architecture can be used in radio propagation channel prediction. U-Net is a convolutional neural network that was developed for biomedical image segmentation at the Computer Science Department of the University of Freiburg. The network is based on the fully convolutional network and its architecture was modified and extended to work with fewer training images and to yield more precise segmentations. The architecture was described by O. Ronneberger, P. Fischer, and T. Brox, in “U-Net: Convolutional Networks for Biomedical Image Segmentation,” in International Conference on Medical Image Computing and Computer-Assisted Intervention (MICCAI), pp. 234-241, November 2015.

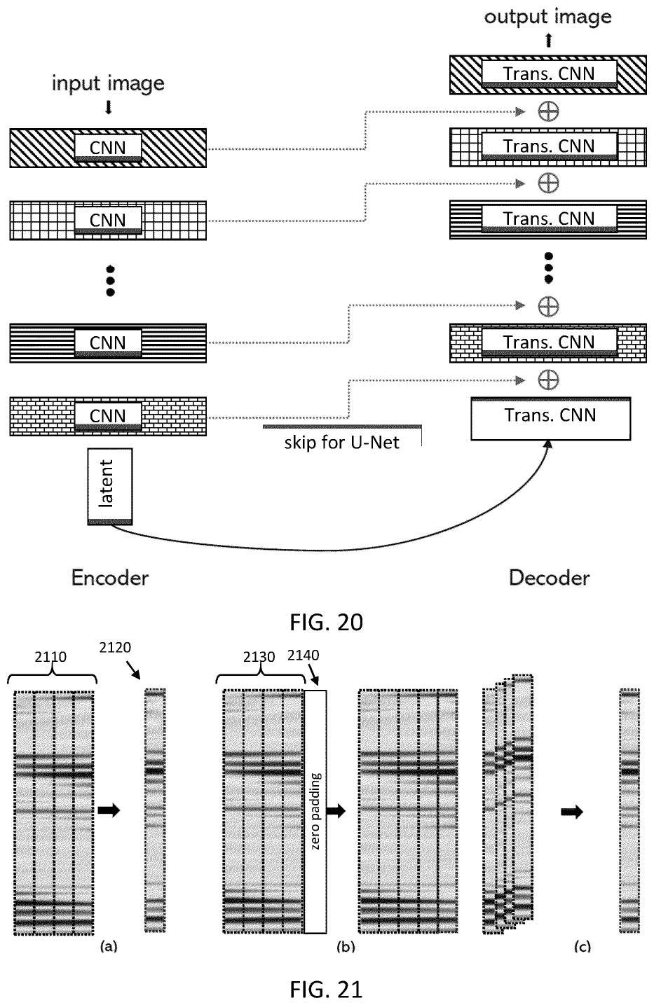

FIG. 20 depicts the U-Net architecture schematically. The architecture comprises a convolutional auto-encoder (AE) with so-called skip connections. A convolutional AE consists of a convolutional encoder on the left-hand side of the figure and a transposed convolutional (also known as up-convolution) decoder on the right-hand side. Applying skip connections for an AE means that for some layers of the encoder the output skips subsequent layers and is instead fed directly as input to corresponding, if being a symmetric skip connection, layer of the decoder. The encoder compresses the input image into a latent vector (code in a latent space), and the decoder constructs the output image from the code generated by the encoder. According to an example, the U-Net uses a symmetric AE architecture with skip network between each layer in the encoder and decoder. This architecture will be referred to as full U-Net herein. In comparison, a U-Net architecture based on an asymmetric AE will be referred to as partial U-Net. It can be shown that the introduction of skip connections to the standard AE as in the U-Net has a profound impact on prediction performance.

All the three example models P_{θ}^{bs}, P_{θ}^{ic}, and P_{θ}^{nf} can be trained by using the same datasets but each model uses different input and output pairs.

With reference to FIG. 21, the baseline model P_{θ}^{bs} takes as input a number of previous channel images 2110 and outputs a predicted hₖ₊₁, as schematically illustrated in FIG. 21(a). The image completion model Pec instead takes as input the previous channel images 2130, where the channel to be predicted hₖ₊₁ has been represented by zero-padding 2140 (this part will then be completed by the image completion algorithm), as illustrated in FIG. 21(b). The baseline model P_{θ}^{bs} uses an asymmetric AE or a partial U-Net to predict a small output image from a large input image that minimizes the loss function l₁. The channel images from the four conditioning state images are combined into a single image and is used as one large conditioning input image for POS. A small output image is readily defined by a ground truth channel image from the target state hₖ₊₁. P_{θ}^{bs} uses this asymmetric AE architecture to perform the required down-sampling by the encoder and up-sampling operation by the decoder to transform the large image input into the small image output.

In order to use a symmetric AE or full U-Net, the input and output images need to have the same size. As explained above, one way to achieve this is to define the input and output pairs for the image completion model Pic by applying a zero padding to the input image. All the five images of hₖ₋₃ to hₖ₋₁ are combined into a single image and used as a target output image for Pic. To match the spatial size between the input and the output image, the same input image as in P_{θ}^{bs} is concatenated with a zero padding size T×F and used as a new input image for Pic. The baseline and image channel completion models are implemented with the first layer of a single CNN channel. In order to make maximum use of processor memory, we can take the four sequential input images into four parallel CNN channels, which leads to next-frame prediction P_{θ}^{nf} (a.k.a. forward video prediction), as illustrated in FIG. 21(c).

FIG. 11 schematically illustrates, in terms of a number of functional units, the general components of a network node according to embodiments of the discussions herein. Processing circuitry 1010 is provided using any combination of one or more of a suitable central processing unit CPU, multiprocessor, microcontroller, digital signal processor DSP, etc., capable of executing software instructions stored in a computer program product, e.g., in the form of a storage medium 1030. The processing circuitry 1010 may further be provided as at least one application specific integrated circuit ASIC, or field programmable gate array FPGA.

Particularly, the processing circuitry 1010 is configured to cause the device to perform a set of operations, or steps, such as the methods discussed in connection to FIG. 4 and the discussions above. For example, the storage medium 1030 may store the set of operations, and the processing circuitry 1010 may be configured to retrieve the set of operations from the storage medium 1030 to cause the device to perform the set of operations. The set of operations may be provided as a set of executable instructions. Thus, the processing circuitry 1010 is thereby arranged to execute methods as herein disclosed. In other words, there is shown a network node comprising processing circuitry 1010, a network interface 1020 coupled to the processing circuitry 1010 and a memory 1030 coupled to the processing circuitry 1010, wherein the memory comprises machine readable computer program instructions that, when executed by the processing circuitry, causes the network node to transmit and to receive a radio frequency waveform.

The storage medium 1030 may also comprise persistent storage, which, for example, can be any single one or combination of magnetic memory, optical memory, solid state memory or even remotely mounted memory.

The device may further comprise an interface 1020 for communications with at least one external device. As such the interface 1020 may comprise one or more transmitters and receivers, comprising analogue and digital components and a suitable number of ports for wireline or wireless communication.

The processing circuitry 1010 controls the general operation of the device e.g., by sending data and control signals to the interface 1020 and the storage medium 1030, by receiving data and reports from the interface 1020, and by retrieving data and instructions from the storage medium 1030. Other components, as well as the related functionality, of the control node are omitted in order not to obscure the concepts presented herein.

The schematic illustration in FIG. 10, and the discussion above, has described a network node 110, 120, 160 comprised in a wireless communication system 100, wherein the network node is configured to facilitate estimation of a radio propagation channel realization 300, 400 between one or more access points 110, 120 and one or more wireless devices 130, 140, the network node comprising processing circuitry 1010 arranged to obtain a generative adversarial network, GAN, structure 500, wherein the GAN structure comprises a generative part 510 and a discriminative part 520, configure the GAN structure 500 as a conditioned GAN structure, where the generative part 510 is arranged to be conditioned by pilot symbol data comprising radio propagation channel data obtained from pilot symbol transmissions over the radio propagation channel, train the GAN structure 500 by conditioning the generative part 510 on the pilot symbol data and feeding a corresponding output from the generative part 510 to the discriminative part 520 together with reference channel realization data corresponding to the pilot symbol data, and extract a channel estimator from the GAN structure 500, the channel estimator being the generative part 510 of the GAN structure.

According to aspects, the processing circuitry is further arranged to estimate a radio propagation channel realization by feeding pilot symbol data to the channel estimator.

According to aspects, the network node comprises a network interface 1020, wherein the processing circuitry is further arranged to transmit the channel estimator to an access point 110, 120 and/or to a wireless device 130, 140 comprised in the wireless communication system 100.

There is also disclosed herein a wireless device 130, 140 comprised in a wireless communication system 100, wherein the wireless device is configured to facilitate estimation of a radio propagation channel realization 300, 400 between one or more access points 110, 120 and the wireless device 130, 140, the wireless device comprising processing circuitry 1010 arranged to obtain a generative adversarial network, GAN, structure 500, wherein the GAN structure comprises a generative part 510 and a discriminative part 520, configure the GAN structure 500 as a conditioned GAN structure, where the generative part 510 is arranged to be conditioned by pilot symbol data comprising radio propagation channel data obtained from pilot symbol transmissions over the radio propagation channel, train the GAN structure 500 by conditioning the generative part 510 on the pilot symbol data and feeding a corresponding output from the generative part 510 to the discriminative part 520 together with reference channel realization data corresponding to the pilot symbol data, and extract a channel estimator from the GAN structure 500, the channel estimator being the generative part 510 of the GAN structure.

According to aspects, the processing circuitry 1010 is further arranged to estimate a radio propagation channel realization by feeding pilot symbol data to the channel estimator.

The wireless device 130, 140 optionally also comprises a network interface 1020, wherein the processing circuitry 1010 is further arranged to transmit the channel estimator to an access point 110, 120 and/or to a wireless device 130, 140 comprised in the wireless communication system 100.

FIG. 11 illustrates a computer readable medium 1110 carrying a computer program comprising program code means 1120 for performing the methods illustrated in, e.g., FIG. 7, when said program product is run on a computer. The computer readable medium and the code means may together form a computer program product 1100.

1. A method for estimation of a radio propagation channel realization, performed in a wireless communication system comprising one or more access points and one or more wireless devices, the method comprising
obtaining a generative adversarial network, GAN, structure, wherein the GAN structure comprises a generative part and a discriminative part,
configuring the GAN structure as a conditioned GAN structure, where the generative part is arranged to be conditioned by pilot symbol data comprising radio propagation channel data obtained from pilot symbol transmissions over the radio propagation channel,
training the GAN structure by conditioning the generative part on the pilot symbol data and feeding a corresponding output from the generative part to the discriminative part together with reference channel realization data corresponding to the pilot symbol data,
extracting a channel estimator from the GAN structure, the channel estimator being the generative part of the GAN structure, and
estimating a radio propagation channel realization by feeding pilot symbol data to the channel estimator.

2. The method according to claim 1, performed in part or entirely in one of the access points, in one of the wireless devices, and/or in a remote server.

3. The method according to claim 1, where the wireless communication system is an orthogonal frequency division multiplexed, OFDM, based system, and the pilot symbol transmissions comprise transmission of Demodulation Reference Signal, DMRS, resource elements, RE, in the OFDM based system.

4. (canceled)

5. The method according to claim 1, wherein the training is performed until a termination criterion associated with a capability of the generative part to generate an output classified as a true channel realization by the discriminative part.

6. The method according to claim 1, comprising performing an offline training procedure comprising generating the pilot symbol data and the reference channel realization data by computer simulation of a radio propagation channel model, the radio propagation channel model comprising any of a 3GPP tapped delay line, TDL, model, a 3GPP clustered delay line, CDL, model, and a 3GPP spatial channel model, SCM, model.

7. (canceled)

8. The method according to claim 6, comprising performing an additional online training procedure involving pilot symbol transmissions over a radio propagation channel between an access point and a wireless device in the wireless communication system.

9. (canceled)

10. The method according to claim 8, comprising performing an online training procedure comprising extracting the pilot symbol data and the reference channel realization data from an ongoing communication in the wireless communication system, the ongoing communication in the wireless communication system comprising either:
a transmission of pilot-weaved frames comprising only known information symbols where the online training procedure comprises training of one or more GAN structures by extracting one or more pre-determined pilot symbol patterns from the received pilot-weaved frames; and/or
transmission of pilot-weaved frames comprising predetermined pilot symbol patterns and pseudo-pilot symbols.

11-13. (canceled)

14. The method according to claim 1, comprising either or both of the following:
training the GAN structure using a respective cross entropy loss function for each of the generative part and the discriminative part; and
training the GAN structure using a loss function comprising an adversarial loss and a Euclidean distance between the output from the generative part and the corresponding reference channel realization data.

15. (canceled)

16. The method according to claim 1, comprising
training the GAN structure at an access point of the wireless communication system based on communication over an uplink, UL, from a first wireless device to the access point, and transmitting the channel estimator to the first wireless device upon the generative part of the GAN structure reaching a predetermined convergence criterion; and
downloading the discriminative part to the first wireless device and using the discriminative part in a fault detection structure at the wireless device.

17-19. (canceled)

20. The method according to claim 1, comprising transmitting a channel estimator trained at a first access point to the wireless device in response to either:
the wireless device performing a handover procedure for service by the first access point, wherein the channel estimator is transmitted by the first access point; or
the wireless device entering a geographical area, wherein the GAN channel estimator is trained based on communication in the geographical area.

21. (canceled)

22. (canceled)

23. The method according to claim 1, comprising transmitting a channel estimator to the wireless device, where the channel estimator has been trained based on communication involving a specific type of wireless device, where the wireless device is associated with the specific type of wireless device.

24. The method according to claim 1, comprising:
training the GAN structure by conditioning the generative part on the pilot symbol data and feeding a corresponding output from the generative part to the discriminative part together with reference channel realization data concurrent with the pilot symbol data, and extracting a channel estimator for estimating a current channel realization from the GAN structure; and
processing a radio transmission received by a network node from an access point or from a wireless device based on the estimated current radio propagation channel realization.

25. (canceled)

26. The method according to claim 1, comprising training the GAN structure by conditioning the generative part on the pilot symbol data and feeding a corresponding output from the generative part to the discriminative part together with reference channel realization data contiguous in time to the pilot symbol data and extracting a channel predictor for estimating a future channel realization from the GAN structure.

27. (canceled)

28. (canceled)

29. (canceled)

30. The method according to claim 1, comprising training the GAN structure to estimate and/or predict a radio propagation channel realization as a channel response comprising complex elements in a MIMO channel matrix, and/or vectors spanning a MIMO channel matrix eigen-vector space and/or a MIMO channel precoding matrix index, PMI.

31. A network node comprised in a wireless communication system, wherein the network node is configured to facilitate estimation of a radio propagation channel realization between one or more access points and one or more wireless devices, the network node comprising processing circuitry arranged to
obtain a generative adversarial network, GAN, structure, wherein the GAN structure comprises a generative part and a discriminative part,
configure the GAN structure as a conditioned GAN structure, where the generative part is arranged to be conditioned by pilot symbol data comprising radio propagation channel data obtained from pilot symbol transmissions over the radio propagation channel,
train the GAN structure by conditioning the generative part on the pilot symbol data and feeding a corresponding output from the generative part to the discriminative part together with reference channel realization data corresponding to the pilot symbol data, and
extract a channel estimator from the GAN structure, the channel estimator being the generative part of the GAN structure.

32. The network node according to claim 31, wherein the processing circuitry is further arranged to estimate a radio propagation channel realization by feeding pilot symbol data to the channel estimator.

33. The network node according to claim 31, comprising a network interface, wherein the processing circuitry is further arranged to transmit the channel estimator to an access point and/or to a wireless device comprised in the wireless communication system.

34. A wireless device comprised in a wireless communication system, wherein the wireless device is configured to facilitate estimation of a radio propagation channel realization between one or more access points and the wireless device, the wireless device comprising processing circuitry arranged to
obtain a generative adversarial network, GAN, structure, wherein the GAN structure comprises a generative part and a discriminative part,
configure the GAN structure as a conditioned GAN structure, where the generative part is arranged to be conditioned by pilot symbol data comprising radio propagation channel data obtained from pilot symbol transmissions over the radio propagation channel,
train the GAN structure by conditioning the generative part on the pilot symbol data and feeding a corresponding output from the generative part to the discriminative part together with reference channel realization data corresponding to the pilot symbol data, and
extract a channel estimator from the GAN structure, the channel estimator being the generative part of the GAN structure.

35. The wireless device according to claim 34, wherein the processing circuitry is further arranged to estimate a radio propagation channel realization by feeding pilot symbol data to the channel estimator.

36. The wireless device according to claim 34, comprising a network interface, wherein the processing circuitry is further arranged to transmit the channel estimator to an access point and/or to a wireless device comprised in the wireless communication system.
